(19) United States
(12) Patent Application Publication
(10) Pub. No.: US 2024/0181976 A1
(43) Pub. Date: Jun. 6, 2024

(54) FIFTH WHEEL TRAILER

(71) Applicant: ALLIANCE RV, INC., Elkhart, IN (US)

(72) Inventors: Ryan GETZ, Elkhart, IN (US); Jeremiah DUMKA, Goshen, IN (US)

(21) Appl. No.: 18/062,193

(22) Filed: Dec. 6, 2022

(51) Int. Cl. B60R 15/04; B60P 3/39; B60R 15/02; B62D 21/20; B62D 53/08

(52) U.S. Cl. CPC B60R 15/04; B60P 3/39; B60R 15/02; B62D 21/20; B62D 53/0842; B60P 3/34

(57) ABSTRACT

A fifth wheel trailer includes a main level and an upper deck located at a greater elevation than the main level. The upper deck includes living space and a bathroom. The bathroom is located adjacent a first side of the trailer, and the bedroom is located adjacent the second side of the trailer opposite the bathroom.

### BACKGROUND OF THE DISCLOSURE

A fifth wheel trailer is a form of towable recreational vehicle having a frame supporting an enclosure defining living and storage space. The frame includes a lower frame portion and an upper frame portion. The lower frame portion is supported by one or more axles and corresponding wheels and tires. The upper frame portion is connected to the lower frame portion through an intervening riser portion. The upper frame portion also is connected to a hitch pin that may be coupled to a pickup truck or other tow vehicle.

The lower frame portion supports a generally level lower floor located at a first height or elevation above the ground on which the trailer may be located. The upper frame portion supports a generally level upper floor located at a second height or elevation above the ground on which the trailer may be located. One or more steps typically provide access between the main level and the upper deck. For example, the upper deck floor may be two, three, four, or more or fewer steps above the main level floor.

The enclosure typically defines one or more bedrooms or sleeping areas, one or more bathrooms, a kitchen, a living room, and may include other living and storage space. Typically, the enclosure includes a lower level (or main level) and an upper level (or upper deck). The kitchen and the living room typically are located on the main level. The main level may also include one or more bathrooms and/or sleeping areas. A bedroom and a bathroom typically are located on the upper deck. The upper deck bathroom typically is located aft of the upper deck bedroom. Some fifth wheel trailers, commonly referred to as toy haulers, include a storage area accessible from the rear of the trailer for carrying motorcycles, bicycles, all-terrain vehicles, and the like. This storage area typically is located rearward of the main living space, and it may be reconfigurable as auxiliary living space.

The length and width of fifth wheel trailers may be the subject of various governmental laws and regulations, private campground restrictions, and/or recreational vehicle industry standards. For example, United States National Parks limit the length of trailers that may be parked there to forty feet. As another example, state or federal departments of transportation may limit the width of trailers that maybe transported without special permits. The RV Industry Association supports a maximum width of 102 inches.

The foregoing restrictions on length and width limit the amount of living and storage space that can be provided within a fifth wheel trailer. Allocation of space for living general results in less space for storage, and vice versa.

It would be desirable to provide a fifth wheel trailer with a floor plan that provides improved allocation of both living and storage space.

### SUMMARY OF THE DISCLOSURE

The present disclosure is directed to a fifth wheel trailer having a bathroom located on the upper deck abutting a side wall of the trailer opposite a bedroom or other living space abutting an opposite side wall of the trailer.

### BRIEF DESCRIPTION OF THE DRAWINGS

FIG. 1 is a perspective view of a typical fifth wheel trailer;

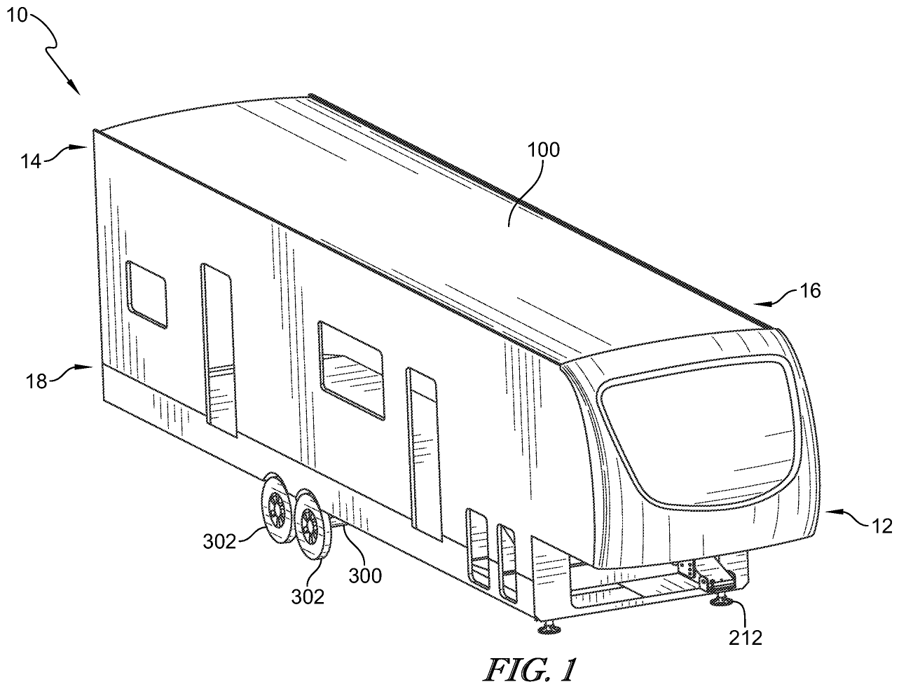

FIG. 2 is a cross-sectional top plan view of a fifth wheel trailer according to the present disclosure having an upper deck slide-out in an extended positions and showing a floor plan thereof;

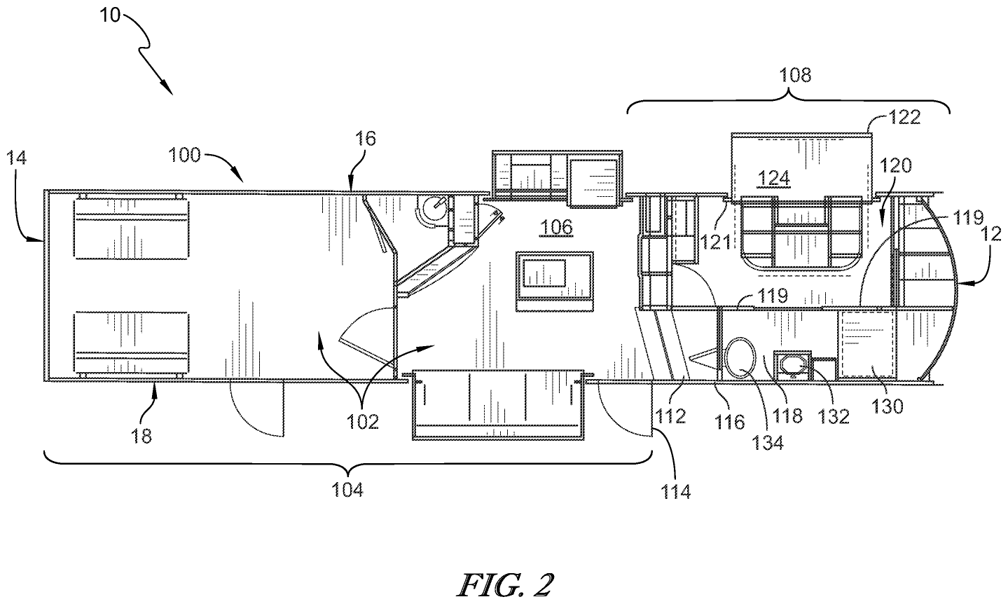

FIG. 3 is a cross-sectional top plan view of the fifth wheel trailer of FIG. 2 having an upper deck slide-out in retracted positions and showing a floor plan thereof;

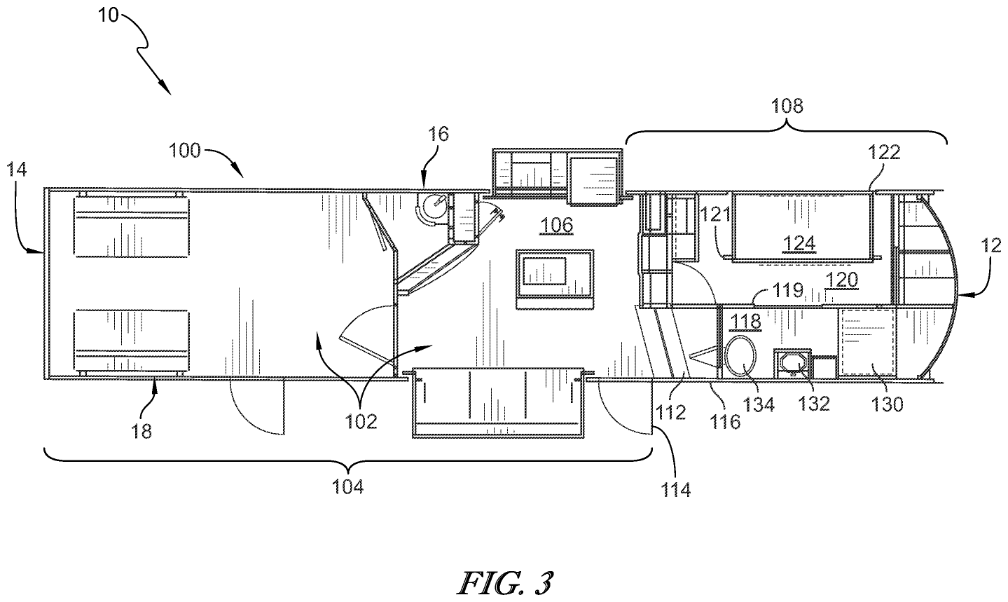

FIG. 4 is a cross-sectional side elevation view of a forward portion of the fifth wheel trailer of FIG. 2 showing a mechanical layout thereof;

FIG. 5 is a top plan view of the frame of the fifth wheel trailer of FIG. 2; and

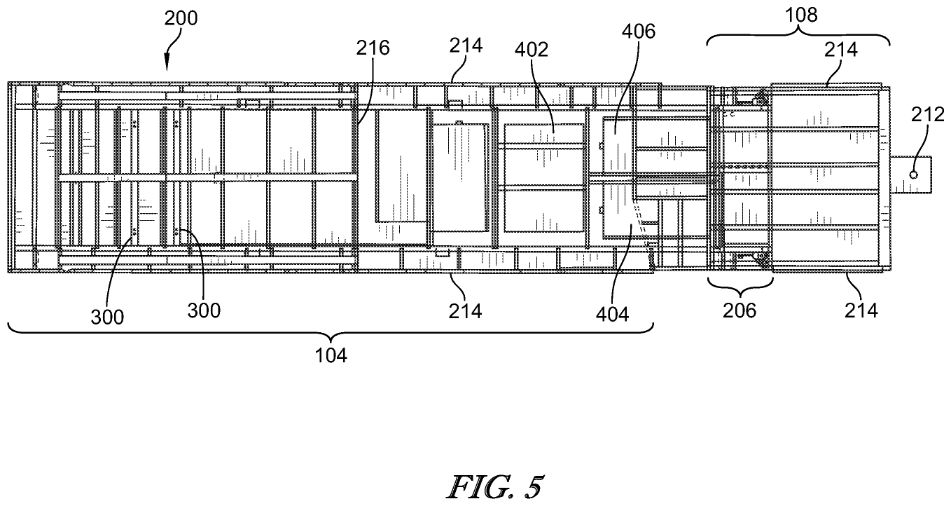

FIG. 6 is a side elevation view of the fifth wheel trailer of FIG. 2.

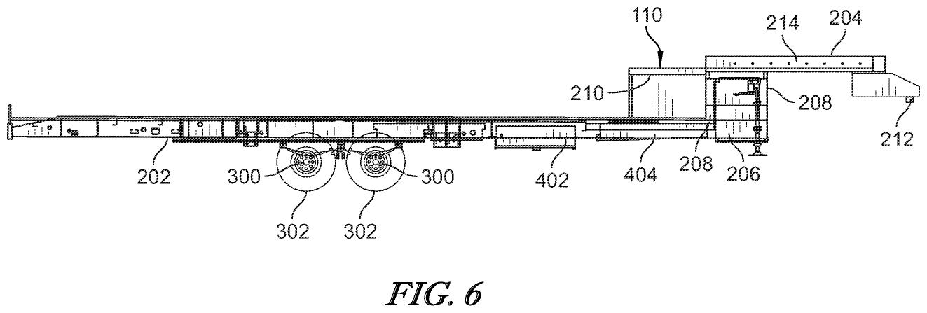

### DETAILED DESCRIPTION OF THE DRAWINGS

References to orientation, for example, front, rear, forward, rearward, top, bottom, upper lower, vertical, horizontal, left, right, and the like, as may be used herein should be construed in a relative, rather than absolute, sense unless context clearly dictates otherwise.

The drawings show a fifth wheel trailer 10 according to the present disclosure. The fifth wheel trailer 10 has a forward end 12, a rearward or aft end 14, a left side 16, and a right side 18.

The fifth wheel trailer 10 includes an enclosure 100 defining an interior space 102, a frame 200 supporting the enclosure 100, and one or more axles 300 and corresponding wheels and tires 302 supporting the frame 200.

The interior space 102 incudes a main or lower level 104 having a main or lower floor 106, and an upper level (or upper deck) 108 having an upper floor 110. The lower level 104 is located at a first height or elevation H1 above the ground on which the trailer may be located, and the upper deck 108 is located a second height or elevation H2 above the ground. The second height H2 is greater than the first height H1, typically by about 24 to 27 inches or more or less. Steps 112 are provided to facilitate access from the lower level 104 to the upper deck 108 and vice versa. An entry door 114 is located in a right side wall 116 of the lower level 104 of the enclosure 100 and provides access between the enclosure 100 and an environment surrounding the enclosure 100.

Similarly, the frame 200 includes a main or lower frame portion 202 and an upper frame portion 204. The lower frame portion 202 supports the lower level 104 of the enclosure 100, including the lower level floor 106 of the enclosure 100, and the upper frame portion 204 supports the upper deck 108 of the enclosure 102, including the upper deck floor 110 of the enclosure 100. An aft portion of the upper frame portion 204 overlaps a forward portion of the lower frame portion 202. A riser (which may be referred to as an upper deck riser) 206 connects the aft portion of the upper frame portion 204 to the forward portion of the lower frame portion 202 in the region where the aft portion of the upper frame portion 204 overlaps the forward portion of the lower frame portion 202. As shown, the riser 206 includes a plurality of columns 208 extending vertically or otherwise between and connecting the upper frame portion 204 to the lower frame portion 202. The riser 206 may include a plurality of stiffeners connecting the columns 208 to each other and/or to the lower frame portion 202 and upper frame portion 204. An upper deck frame extension 210 extends aft of the riser 206. The upper deck frame extension 210 is configured to support portions of the upper deck floor 110 that may extend aft of the riser 206. The upper frame portion 204 is connected to a hitch pin 212 configured to engage with a hitch of a tow vehicle (not shown).

Each of the lower frame portion 202 and the upper frame portion 204 may include two or more beams 214 or other structural members extending in a fore-and-aft (or longitudinal) direction, and two or more cross members 216 extending in a side-to-side (or lateral) direction and connecting together the beams 214.

The frame 200 supports various mechanical and electrical equipment. For example, the lower frame portion 202 supports a first water tank (which may be referred to herein as a clean water tank) 402 for carrying potable water (clean water), a second water tank (which may be referred to herein as a black water tank) 404 for carrying waste water from toilets (sewage), and a third water tank 406 (which may be referred to herein as a grey water tank) for carrying waste water from sinks, showers, and other plumbed fixtures not including toilets (grey water). In embodiments, the second water tank 404 could be configured to also carry grey water, and the third water tank 406 and could be omitted. Some embodiments could include more than one black water and/or more than one grey water tank.

The water tanks 402, 404, 406 are carried by the lower frame portion 202. The water tanks 402, 404, 406 are shown as being located between the beams 214 and the cross members 216 of the lower frame portion 202. In embodiments, one or more of the water tanks 402, 404, 406 could be borne upon the beams 214 and/or the cross members 216, or carried below the beams 214 and/or the cross members 216.

As shown, the black water tank 404 and the grey water 406 are arranged side-by-side proximate the forward end of the lower frame portion 202 and at of the riser 206 and the aft end of the upper frame portion 204, with the black water tank 404 proximate the right side 18 of the frame 200 and the grey water tank 406 proximate the left side 16 of the frame 200. As suggested above, the grey water tank 406 could be omitted and grey water could be routed to the black water tank 404, instead.

The upper deck 108 of the trailer 10 includes a bathroom 118 and a bedroom 120 disposed in the upper deck 108 upon the upper deck floor 110. The bathroom 118 is adjacent, and (as shown) may abut, a first side, for example, the right side 18, of the upper deck 108. The bedroom 120 is adjacent and may abut a second side, for example, the left side 16, of the upper deck 108. As shown, the bedroom 120 includes a slide out 122 which includes a bed 124. The bed 124 is oriented cross-wise with respect to the trailer 10, with its head proximate the left side 16 of the trailer 10 and its foot proximate the right side 18 of the trailer 10. The slide out 122 is extendable and retractable through a left side wall 126 of the trailer 10, opposite the bathroom 118. The slide out 122 may be extended when the trailer 10 is parked so as to increase the floor area of, and the usable living space within, the bedroom 120 and the upper deck 108 generally. The slide out 122 may be retracted when the trailer 10 is being transported. The bed 124 may be foldable (for example, the foot of the bed 124 may be foldable about a hinge 121 toward the head of the bed 124) in order to provide clearance between the bed 124 and an interior wall 119 between the bathroom 118 and the bedroom 120 when the slide out 122 is retracted.

As shown, the bathroom 118 includes three plumbing fixtures, namely a shower or other bathing fixture 130 (for example, a bathtub), a sink 132, and a toilet 134. Any or all of the shower 130, the sink 132, and the toilet 134 may be located forward of any or all of the clean, black, and grey water tanks 402, 404, 406. As shown, the shower 130 is proximate the forward end 12 of the trailer 10, the sink 132 is aft of the shower 130, and the toilet 134 is aft of the sink 132. In embodiments, the relative locations of the shower 130, sink 132, and toilet 134 could be changed, though the toilet 134 typically would be located so that the corresponding drain pipe can be run substantially vertically from the toilet 134 to the black water tank 404.

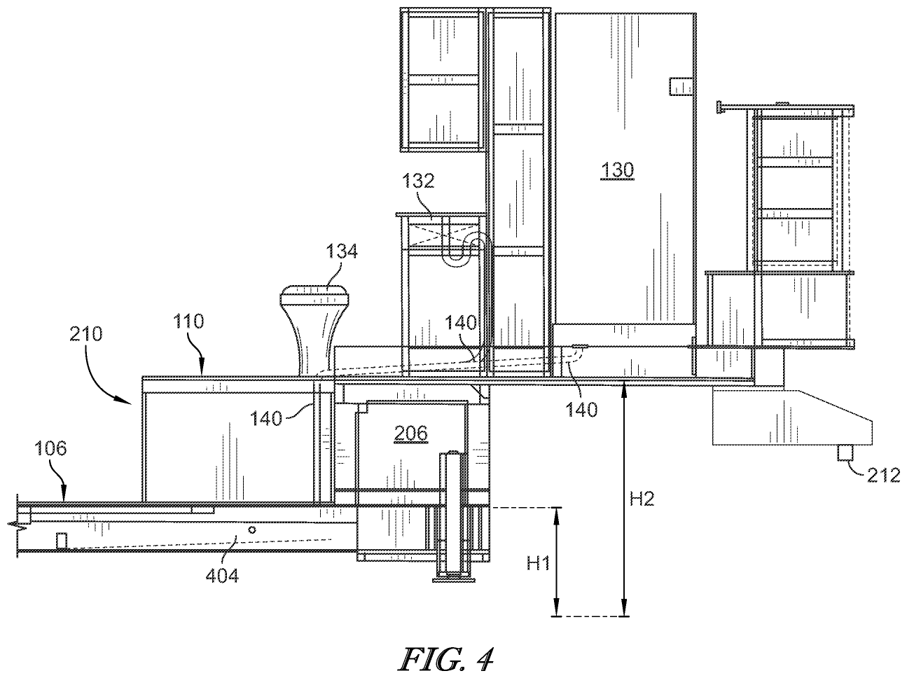

As shown, the shower 130 and the sink 132 may be located upon the upper deck floor 110 above the upper frame portion 204, and the drains therefrom may be routed both horizontally and vertically to the grey water tank 406. As best shown in FIG. 4, drain lines 140 from the shower 130 and the sink 132 to the grey water tank 406 extend at least horizontally above the upper deck floor 110 within the enclosure 100, the walls, floors, and ceiling of which may be insulated. Also, water supply lines (not shown) to the shower 130 and the sink 132 extend at least horizontally above the upper deck floor 110. As shown, the toilet 134 is located upon the upper deck floor 110 generally above the black water tank 404 so that waste from the toilet 134 may be routed substantially vertically from the toilet 134 to the black water tank 404 through a corresponding drain pipe 140. As such, the toilet 134 may be at located at least partially upon the upper deck frame extension 210 extending aft of the upper frame portion 204 and the riser 206. In embodiments, the toilet 134 may be located forward of the black water tank 404 so that the corresponding drain pipe 140 and water supply line (not shown) extend at least horizontally above the upper deck floor 110. In embodiments, the bathroom could include more or fewer than three plumbing fixtures.

The entry door 114 and the bathroom 118 are described and shown as being proximate the right side 18 of the trailer 10, and the bedroom 120 is described and shown as being proximate the left side 16 of the trailer 10. In embodiments, the entry door 114 and the bathroom 118 could proximate the right side 18 of the trailer, and the bedroom 120 could be proximate the left side of the trailer 10.

Although the trailer 10 has been referred to herein as a fifth wheel trailer, it alternatively could be a gooseneck trailer. As such, the term fifth wheel trailer as used herein should be understood to encompass gooseneck trailers.

One or more embodiments of a fifth wheel trailer are illustrated and described. Features disclosed in connection with a given embodiment may be employed in other embodiments to the greatest extent possible. One skilled in the art would recognize that additional embodiments may fall within the scope of the invention as claimed below.

1. A fifth wheel trailer having a forward end, a rearward end, and first and second sides extending from the forward end to the rearward end, the fifth wheel trailer comprising:
a frame, the frame comprising a lower frame portion at a first elevation and an upper frame portion at a second elevation higher than the first elevation, the upper frame portion extending from the lower frame portion toward the forward end of the fifth wheel trailer and the lower frame portion extending from the upper frame portion toward the rearward end of the fifth wheel trailer, wherein a rearward end of the upper frame portion overlaps a forward end of the lower portion, and a riser connecting the rearward end of the upper frame portion to the forward end of the lower frame portion;
a first water tank configured to hold clean water mounted to the lower frame portion proximate a forward end of the lower frame portion and rearward of the riser and the upper frame portion;
a second water tank configured to hold waste water mounted to the lower frame portion proximate a forward end of the lower frame portion and rearward of the riser and the upper frame portion;
an enclosure disposed upon the frame, the enclosure having a lower enclosure portion extending in an upward direction from the lower frame portion, and an upper enclosure portion extending in an upward direction from the upper frame portion;
wherein the upper enclosure portion includes an upper deck floor, a bathroom upon the upper deck floor and adjacent the first side of the fifth wheel trailer, and a living area upon the upper deck floor and adjacent the second side of the fifth wheel trailer opposite the living area; and
wherein the bathroom includes at least one plumbing fixture.

2. The fifth wheel trailer of claim 1 wherein the bathroom is forward of and spaced from at least one of the first water tank and the second water tank.

3. The fifth wheel trailer of claim 1 wherein the bathroom is forward of and spaced from both the first water tank and the second water tank.

4. The fifth wheel trailer of claim 1 having an overall length of no more than 40 feet.

5. The fifth wheel trailer of claim 1 comprising no more than two axles configured to support the frame.

6. The fifth wheel trailer of claim 1 wherein the second elevation is at least 24 inches higher than the first elevation.

7. The fifth wheel trailer of claim 1 further comprising a hitch pin connected to the upper frame portion.

8. The fifth wheel trailer of claim 1 further comprising piping extending horizontally above the upper deck floor between the at least one plumbing fixture and a respective one of the first water tank and the second water tank.

9. The fifth wheel trailer of claim 8 wherein the piping comprises one of drain piping and supply piping.

10. The fifth wheel trailer of claim 9 wherein the piping further comprises the other of drain piping and supply piping.

11. The fifth wheel trailer of claim 1 wherein at least two steps separate the upper deck floor vertically from the lower deck floor.

12. The fifth wheel trailer of claim 1 wherein the one or more plumbing fixtures comprises one of a sink, a bathing fixture, and a toilet.

13. The fifth wheel trailer of claim 1 wherein the one or more plumbing fixtures comprises two of a sink, a bathing fixture, and a toilet.

14. The fifth wheel wherein the one or more plumbing fixtures comprises a sink, a bathing fixture, and a toilet.

15. The fifth wheel trailer of claim 1 where the at least one plumbing fixture is forward of the at least one of the first water tank and the second water tank.

16. A fifth wheel trailer having a forward end, a rearward end, and first and second sides extending from the forward end to the rearward end, the fifth wheel trailer comprising:
a frame, the frame comprising a lower frame portion at a first elevation and an upper frame portion at a second elevation higher than the first elevation, the upper frame portion extending from the lower frame portion toward the forward end of the fifth wheel trailer and the lower frame portion extending from the upper frame portion toward the rearward end of the fifth wheel trailer, wherein a rearward end of the upper frame portion overlaps a forward end of the lower portion, and a riser connecting the rearward end of the upper frame portion to the forward end of the lower frame portion;
a first water tank configured to hold clean water mounted to the lower frame portion proximate a forward end of the lower frame portion and rearward of the riser and the upper frame portion;
a second water tank configured to hold waste water mounted to the lower frame portion proximate a forward end of the lower frame portion and rearward of the riser and the upper frame portion;
an enclosure disposed upon the frame, the enclosure having a lower enclosure portion extending in an upward direction from the lower frame portion, and an upper enclosure portion extending in an upward direction from the upper frame portion;
wherein the upper enclosure portion includes an upper deck floor, a bathroom upon the upper deck floor and adjacent the first side of the fifth wheel trailer, and a living area upon the upper deck floor and adjacent the second side of the fifth wheel trailer opposite the living area;
wherein the bathroom includes a sink, a shower and a toilet; and
wherein at least one the sink and shower is forward of at least one of the first water tank and the second water tank.
